(19) United States
(12) Patent Application Publication
(10) Pub. No.: US 2022/0066253 A1
(43) Pub. Date: Mar. 3, 2022

(54) LIQUID CRYSTAL ON SILICON (LCOS) DEVICE AND LCOS DISPLAY PANEL

(71) Applicant: OMNIVISION SEMICONDUCTOR (SHANGHAI) CO., LTD., Shanghai (CN)

(72) Inventors: Chun-Sheng FAN, Hsinchu City (TW); Regis FAN, Sunnyvale, CA (US)

(21) Appl. No.: 17/077,800

(22) Filed: Oct. 22, 2020

(30) Foreign Application Priority Data
Aug. 27, 2020 (CN) 202010879839.2

(51) Int. Cl. G02F 1/1343; G02F 1/1333; G02F 1/1337; G02F 1/1339; G02F 1/1362

(52) U.S. Cl. CPC G02F 1/13439; G02F 1/133345; G02F 1/134309; G02F 2201/123; G02F 1/1339; G02F 1/136277; G02F 1/1337

(57) ABSTRACT

A liquid crystal on silicon (LCOS) device and a LCOS display panel are disclosed. The LCOS device includes: at least two first pixel electrodes each having a substantially rectangular cross-section, the first pixel electrodes each having four cutaway corners and arranged on the substrate along the first diagonal direction; a first insulating layer filled between sidewalls of adjacent first pixel electrodes and covering the first pixel electrodes; at least two second pixel electrodes each having a substantially rectangular cross-section and arranged on the first insulating layer along the second diagonal direction, in a projection plane parallel to a surface of the substrate: the second pixel electrodes are alternately arranged with the first pixel electrodes in the length direction; and an inter-pixel gap is formed between corners of adjacent second pixel electrodes along the second diagonal direction and between cutaway corners of adjacent first pixel electrodes along the first diagonal direction.

### CROSS-REFERENCES TO RELATED APPLICATION

This application claims the priority of Chinese patent application number 202010879839.2, filed on Aug. 27, 2020, the entire contents of which are incorporated herein by reference.

### TECHNICAL FIELD

The present invention relates to the field of liquid crystal displays and, in particular, to a liquid crystal on silicon (LCOS) device and a LCOS display panel.

### BACKGROUND

A liquid crystal on silicon (LCOS) display panel is a miniaturized reflective liquid crystal panel that “projects” color images based on liquid crystal control accomplished by semiconductor silicon crystal technology. A LCOS display panel is advantageous in utilizing light with high efficiency, having a compact size and a high aperture ratio, allowing fabrication using established techniques and easily displaying high-resolution images with sufficient color rendering.

A LCOS display panel typically includes a LCOS device and a transparent cover plate that is bonded to the LCOS device with a sealant, thus packaging the liquid crystal material therein. The structure and performance of the LCOS device have a great impact on the overall performance of the LCOS display panel.

Reference is now made to FIG. 1, a schematic top view of a LCOS device. As can be seen from FIG. 1, the LCOS device includes a plurality of pixel electrodes 11 that are periodically arranged in such a manner that each pixel electrode 11 is separated from any other by surrounding inter-pixel gaps 12. Reference is now made to FIG. 2, a schematic cross-sectional view of the LCOS device of FIG. 1 taken along line AA′. As can be seen from FIG. 2, the LCOS device includes a substrate 10 on which the plurality of pixel electrodes 11 are formed, with each pixel electrode 11 being separated from the substrate 10 by a dielectric layer 13. Inter-pixel gaps 12 between adjacent pixel electrodes 11 are filled with an insulating barrier layer 14, and both the pixel electrodes 11 and the insulating barrier layer 14 are covered with an insulating passivation layer 15. With the structure of the conventional LCOS device shown in FIGS. 1 and 2, assuming each pixel has a width D1 of 4.5 μm (defined as the sum of widths of one pixel electrode 11 and one inter-pixel gap 12) and the width D2 of each inter-pixel gap 12 is 0.2 μm, the LCOS display panel will have a pixel aperture ratio only of 91.3%. Reference is made additionally to FIG. 3, a diagram showing evolution of reflectance on the basis of the LCOS device of FIG. 1 vs. wavelength in the visible range, in which the pixel electrodes 11 are made of aluminum, and the curves L1, L2 and L3 correspond to thicknesses of the pixel electrodes 11 of 30 nm, 40 nm and greater than 50 nm, respectively. As can be seen from FIG. 3, the reflectance increases with the thickness of the pixel electrodes 11 in the visible range but reaches an upper limit at a thickness of over 50 nm. Therefore, further increasing reflectance of the conventional LCOS device based on the structure shown in FIGS. 1 and 2 requires increasing its aperture ratio, which necessitates the use of more expensive sub-nanometer wafer processing techniques and will lead to a surge in cost of fabrication.

Therefore, there is a need for structural improvements in conventional LCOS devices, which should allow increases in aperture ratio and hence in reflectance while avoiding a significant cost increase.

### SUMMARY OF THE INVENTION

It is an objective of the present invention to provide a LCOS device and a LCOS display panel, which exhibit an increased aperture ratio and higher reflectance while not leading to a significant increase in cost.

To this end, the provided LCOS device includes:

a substrate;

at least two first pixel electrodes each having a substantially rectangular cross-section defining a first diagonal direction, a second diagonal direction and a length direction, each of the at least two first pixel electrodes having four cutaway corners, the at least two first pixel electrodes being arranged on the substrate along the first diagonal direction;

a first insulating layer, which is filled between sidewalls of adjacent first pixel electrodes and covers the first pixel electrodes;

at least two second pixel electrodes each having a substantially rectangular cross-section and arranged on the first insulating layer along the second diagonal direction, wherein in a projection plane parallel to a surface of the substrate: the second pixel electrodes are alternately arranged with the first pixel electrodes in the length direction; and an inter-pixel gap is formed between corners of adjacent second pixel electrodes along the second diagonal direction and also between cutaway corners of adjacent first pixel electrodes along the first diagonal direction; and

a second insulating layer, which is filled between sidewalls of adjacent second pixel electrodes.

Optionally, the four cutaway corners of the first pixel electrodes may be chamfered corners.

Optionally, each side of each of the second pixel electrodes may be aligned with an underlying side of a corresponding one of the first pixel electrodes.

Optionally, an edge portion along each side of each of the second pixel electrodes may overlap an underlying side of a corresponding one of the first pixel electrodes.

Optionally, each of the second pixel electrodes may have four cutaway corners, and wherein the four cutaway corners of the second pixel electrodes are chamfered corners.

Optionally, each of the first and second pixel electrodes may have a substantially square cross-section.

Optionally, each of the second pixel electrodes may have four corners that are not cutaway corners.

Optionally, each of the first pixel electrodes may have a thickness of from 220 nm to 260 nm and each of the second pixel electrodes may have a thickness of from 30 nm to 50 nm.

Optionally, a first dielectric layer may be formed between each of the first pixel electrodes and the substrate and a second dielectric layer may be formed between each of the second pixel electrodes and the first insulating layer.

Optionally, conductive plugs may be formed through the first insulating layer to electrically connect the second dielectric layers to the substrate.

Optionally, the LCOS device may further include an insulating passivation layer and an alignment layer, the insulating passivation layer covering both the second pixel electrodes and the second insulating layer, the alignment layer covering the insulating passivation layer.

The present invention also provides a LCOS display panel, which includes the LCOS device as defined above, a liquid crystal layer and a transparent cover plate. The LCOS device is bonded to the transparent cover plate by a sealant, and the liquid crystal layer is sandwiched between the LCOS device and the transparent cover plate.

Compared with the prior art, the present invention offers the following benefits:

1. By including the at least two first pixel electrodes, each corner of each of which is a cutaway corner, and all of which are periodically arranged on the substrate along diagonal directions defined by the cutaway corners, and the at least two second pixel electrodes which are periodically arranged on the first insulating layer along the diagonal directions and are staggered relative to the first pixel electrodes so that inter-pixel gaps are formed between adjacent corners of the second pixel electrodes along the diagonal directions and respective adjacent cutaway corners of the first pixel electrodes along the same directions, the LCOS device achieves an improved aperture ratio and hence enhanced reflectance while avoiding a significant increase in cost.

2. By incorporating the LCOS device that achieves an improved aperture ratio and hence enhanced reflectance not at the expense of a significant increase in cost, the LCOS display panel obtains significantly improved display performance.

### BRIEF DESCRIPTION OF THE DRAWINGS

FIG. 1 is a schematic top view of a conventional LCOS device.

FIG. 2 is a schematic cross-sectional view of the LCOS device of FIG. 1 taken along line AA′.

FIG. 3 shows evolution of reflectance on the basis of the LCOS device of FIG. 1.

FIG. 4 is a schematic top view of a LCOS device according to an embodiment of the present invention.

FIG. 5 is a schematic top perspective view of the LCOS device of FIG. 4.

FIG. 6 is a schematic cross-sectional view of the LCOS device of FIG. 4 taken along line BB′.

FIG. 7 is an exploded view of the LCOS device of FIG. 4.

FIG. 8 is a schematic top view of a LCOS device according to another embodiment of the present invention.

FIGS. 9a and 9b are schematic top views of a LCOS device according to still another embodiment of the present invention.

FIG. 10 shows a comparison between reflectance profiles of a LCOS device according to an embodiment of the present invention and the conventional LCOS device.

In these figures:

10—substrate; 11—pixel electrode; 12—inter-pixel gap; 13—dielectric layer; 14—insulating barrier layer; 15—insulating passivation layer; 20—substrate; 21—first pixel electrode; 211—first dielectric layer; 212—gap; 213—vacancy; 22—first insulating layer; 23—second pixel electrode; 231—second dielectric layer; 24—second insulating layer; 25—conductive plug; 26—insulating passivation layer.

### DETAILED DESCRIPTION

Objectives, advantages and features of the present invention will become more apparent upon reading the following more detailed description of LCOS and LCOS display panels proposed herein. Note that the accompanying drawings are provided in a very simplified form not necessarily drawn to scale, with their only intention to facilitate convenience and clarity in explaining embodiments disclosed herein.

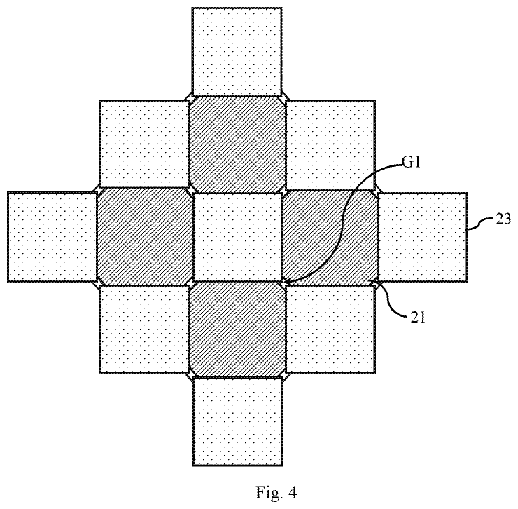

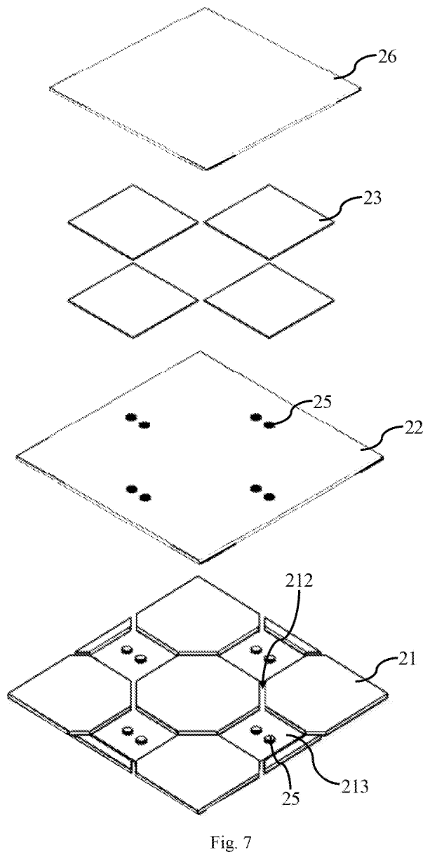

In one embodiment of the present invention, there is provided a liquid crystal on silicon (LCOS) device, which includes, as shown in FIGS. 4 to 9b, a substrate 20, at least two first pixel electrodes 21, a first insulating layer 22, at least two second pixel electrodes 23 and a second insulating layer 24. Each first pixel electrode 21 has a substantially rectangular cross-section defining a first diagonal direction, a second diagonal direction and a length direction. Each corner of each first pixel electrode 21 is a cutaway corner, and all the first pixel electrodes 21 are arranged on the substrate 20 along the first diagonal direction. The first insulating layer 22 is filled between sidewalls of adjacent first pixel electrodes 21 and covers the first pixel electrodes 21. The at least two second pixel electrodes 23 are arranged on the first insulating layer 22 along the second diagonal direction in such a manner that in a projection plane parallel to a surface of the substrate: the second pixel electrodes 23 are alternately arranged with the first pixel electrodes 21 in the length direction, and inter-pixel gaps are formed between corners of adjacent second pixel electrodes 23 along the second diagonal direction and respective cutaway corners of adjacent first pixel electrodes 21 along the first diagonal direction. The second insulating layer 24 is filled between sidewalls of adjacent second pixel electrodes 23.

The LCOS device according to this embodiment will be described in greater detail with reference to FIGS. 4 to 10.

The substrate 20 may be made of any suitable material(s) known to those skilled in the art, such as at least one of silicon, germanium, silicon germanium, silicon carbide, silicon germanium carbide, indium arsenide, gallium arsenide, indium phosphide and the like. Alternatively, the substrate may be a silicon on insulator, strained silicon on insulator, strained silicon germanium on insulator, silicon germanium on insulator or germanium on insulator substrate or the like. The substrate 20 contains structures such as circuits and MOS transistors.

Each corner of each first pixel electrode 21 is a cutaway corner, and all the first pixel electrodes 21 are arranged on the substrate 20 along the diagonal direction defined by the cutaway corners. That is, all the first pixel electrodes 21 are periodically arranged side by side along the diagonals of each first pixel electrode 21. Additionally, in the diagonal directions, adjacent cutaway corners of the first pixel electrodes 21 are spaced apart from each other. In other words, each first pixel electrode 21 is partially removed at each corner so that each of its corners is a cutaway corner. With the cutaway corners of one first pixel electrode 21 as reference ones, each of the other first pixel electrodes 21 is arranged so that its cutaway corners are oriented in the same manner as the respective reference corners and adjacent corners face, and are spaced apart from, each other. In this way, all the first pixel electrodes 21 are periodically arranged on the substrate 20.

Referring to FIGS. 4, 5 and 7, with each first pixel electrode 21 having a square cross-section as an example, each of the squares is partially removed at its four corners so that each of its corners is a cutaway corner. All the first pixel electrodes 21 are arranged along the direction defined by the four cutaway corners of each first pixel electrode. Adjacent cutaway corners of adjacent first pixel electrodes 21 are spaced apart from each other so that the first pixel electrodes 21 are insulated from one another. As can be seen from FIGS. 4, 5 and 7, for any two adjacent first pixel electrodes 21 with two respective adjacent cutaway corners, the two sides that form one of the corners are parallel to the two respective sides that form the other.

The cutaway corners of the first pixel electrodes 21 may be chamfered corners. That is, the sidewalls at the cutaway corners of the first pixel electrodes 21 are beveled. For any two adjacent first pixel electrodes 21 with two respective adjacent cutaway corners, the sidewalls at the respective cutaway corners may be spaced apart from each other by a distance gradually decreasing from the top downward.

Each first pixel electrode 21 is separated from the substrate 20 by a first dielectric layer 211 disposed therebetween.

The first pixel electrodes 21 may be formed of at least one of magnesium, copper, aluminum, titanium, tantalum, gold, zinc and silver and may have a thickness ranging from 220 nm to 260 nm (e.g., 230 nm, 240 nm, etc.). It is to be noted that the material and thickness of the first pixel electrodes 21 are not limited to the enumerated list and range and may be appropriately chosen as required by the desired performance of the device. Examples of the material from which the first dielectric layers 211 is fabricated may include, but are not limited to, at least one of titanium dioxide, tantalum pentoxide, hafnium dioxide, titanium nitride, tantalum mononitride, zinc oxide and magnesium fluoride. The thickness of the first dielectric layers 211 may range from 30 nm to 50 nm.

The first insulating layer 22 is filled between sidewalls of adjacent first pixel electrodes 21 and covers the first pixel electrodes 21. That is, the first insulating layer 22 isolates adjacent first pixel electrodes 21 and buries the first pixel electrodes 21 therein.

The first pixel electrodes 21 are periodically arranged along the diagonal directions defined by their cutaway corners such as to form gaps 212 between adjacent cutaway corners of adjacent first pixel electrodes 21 and vacancies 213 surrounded by the first pixel electrodes 21. The gaps 212 communicate with the vacancies 213, and they are both filled up by the first insulating layer 22. Referring to FIGS. 5 to 7, four first pixel electrodes 21 are arranged with their adjacent cutaway corners spaced apart from each other so that a vacancy 213 is delimited by one side of each of the four first pixel electrodes 21 (i.e., by a total of four sides). The vacancy 213 communicates with the gaps 212 between the adjacent cutaway corners of the four first pixel electrodes 21.

The first insulating layer 22 may be made of at least one of silica, silicon nitride and silicon oxynitride, or of any other suitable insulating material.

The at least two second pixel electrodes 23 are periodically arranged along the diagonal directions on the first insulating layer 22 so that adjacent corners of the second pixel electrodes 23 are spaced apart from each other along the diagonal directions. In other words, with the corners of one second pixel electrode 23 as reference ones, each of the other second pixel electrodes 23 is so arranged that its corners are oriented in the same manner as the respective reference corners and adjacent corners face, and are spaced apart from, each other. In this way, all the second pixel electrodes 23 are periodically arranged on the first insulating layer 22.

The corners of the second pixel electrodes 23 may be all cutaway corners or not. That is, each corner of each second pixel electrode 23 may be either partially removed so as to become a cutaway corner, or not so processed. In the former case, each corner of each second pixel electrode 23 may be a chamfered corner. That is, the sidewalls at the cutaway corners of the second pixel electrodes 23 are beveled. For any two second pixel electrodes 23 that are diagonally adjacent to each other at their respective cutaway corners, the sidewalls at the respective cutaway corners may be spaced apart from each other by a distance gradually decreasing from the top downward.

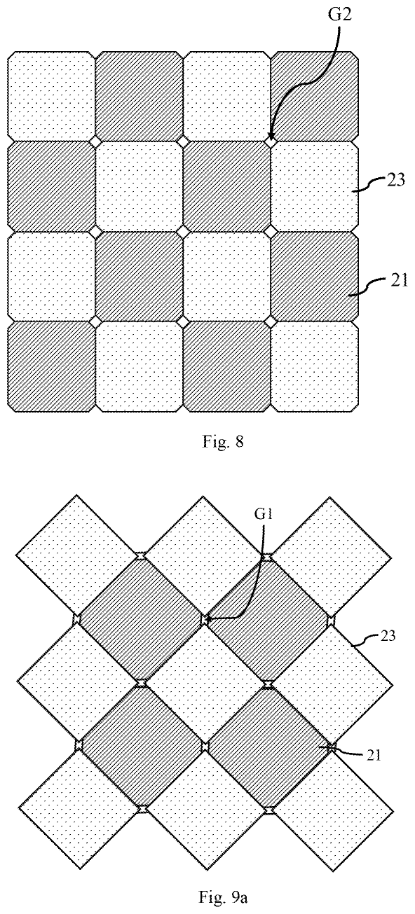

Referring to FIGS. 4, 5 and 7, with each second pixel electrode 23 having a square cross-section with intact corners that are not removed at all, as an example, all the second pixel electrodes 23 are periodically arranged along the diagonal directions, and adjacent corners of adjacent second pixel electrodes 23 are spaced apart from each other so that the second pixel electrodes 23 are insulated from one another. As can be seen from FIGS. 4, 5 and 7, the four corners of each second pixel electrode 23 are all right-angle corners. In the case shown in FIG. 8, each second pixel electrode 23 having a square cross-section with four corners that have been partially removed and become cutaway corners.

The second pixel electrodes 23 are staggered with respect to the first pixel electrodes 21. As can be seen from FIG. 5, the second pixel electrodes 23 are superimposed over respective vacancies 213 delimited by the first pixel electrodes 21. Each side of each second pixel electrode 23 may be aligned with an underlying side of a corresponding first pixel electrode 21. Alternatively, an edge portion along each side of each second pixel electrode 23 overlaps an underlying edge portion of a corresponding first pixel electrode 21.

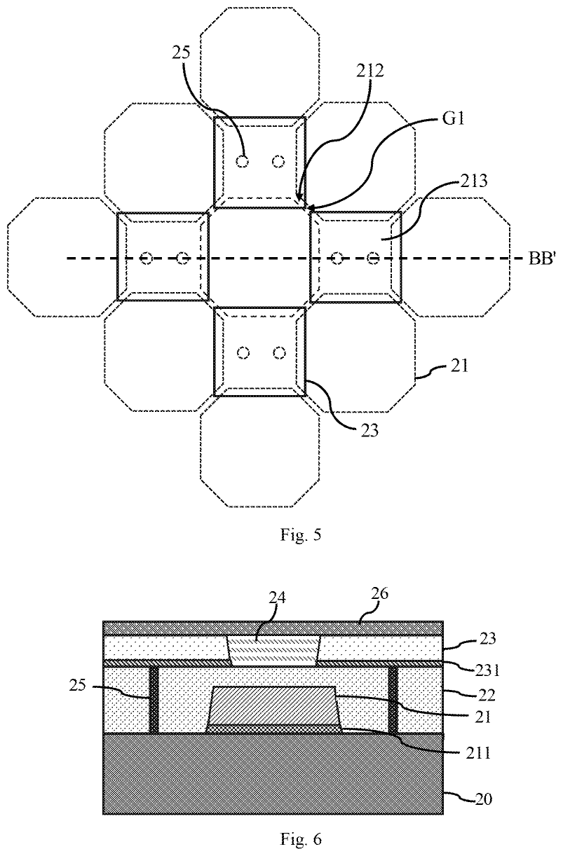

Referring to FIGS. 4 and 5, inter-pixel gaps G1 are formed between adjacent corners of the second pixel electrodes 23 along the diagonal directions and respective adjacent cutaway corners of the underlying first pixel electrodes 21 along the same directions. The inter-pixel gaps G1 are not overlapped either by the first pixel electrodes 21 or by the second pixel electrodes 23. In case of each side of each second pixel electrode 23 being aligned with an underlying side of a corresponding first pixel electrode 21, the second pixel electrodes 23 snugly overlap the respective vacancies 213 and do not extend over the underlying first pixel electrodes 21 at all, without leaving any gaps between sides of the second pixel electrodes 23 and respective sides of the first pixel electrodes 21 in the direction parallel to the second pixel electrodes 23. In this case, the gaps 212 are not overlapped by the second pixel electrodes 23 and thus provide the inter-pixel gaps G1. In case of an edge portion along each side of each second pixel electrode 23 overlapping an underlying edge portion of a corresponding first pixel electrode 21, as shown in FIGS. 5 and 6, the coverage of each second pixel electrode 23 extends beyond the respective vacancy 213. As a result, there are also no gaps left between sides of the second pixel electrodes 23 and respective sides of the first pixel electrodes 21 in the direction parallel to the second pixel electrodes 23. In this case, as each corner of the second pixel electrodes 23 overlaps part of an underlying gap 212, the inter-pixel gaps G1 are smaller in area than the gaps 212.

Compared to the case as shown in FIGS. 4 and 5, each corner of each second pixel electrode 23 in FIG. 8 is a cutaway corner, and inter-pixel gaps G2 are formed between adjacent cutaway corners of the second pixel electrodes 23 along the diagonal directions and respective adjacent cutaway corners of the underlying first pixel electrodes 21 along the same directions, the inter-pixel gaps G2 are greater in area than the inter-pixel gaps G1.

Each second pixel electrode 23 is separated from the first insulating layer 22 by a second dielectric layer 231 disposed therebetween.

The second pixel electrodes 23 may be formed of at least one of magnesium, copper, aluminum, titanium, tantalum, gold, zinc and silver and may have a thickness ranging from 30 nm to 50 nm (e.g., 35 nm, 40 nm, 45 nm etc.). It is to be noted that the material and thickness of the second pixel electrodes 23 are not limited to the enumerated list and range and may be appropriately chosen as required by the desired performance of the device. Examples of the material from which the second dielectric layers 231 is fabricated may include, but are not limited to, at least one of titanium dioxide, tantalum pentoxide, hafnium dioxide, titanium nitride, tantalum mononitride, zinc oxide and magnesium fluoride. The thickness of the second dielectric layers 231 may range from 20 nm to 40 nm.

Reference is now made to FIGS. 4, 8, 9a and 9b, in which the orientations of the first and second pixel electrodes 21, 23 in FIG. 9a are both rotated by 45 degrees from those in FIG. 4. Likewise, the orientations of the first and second pixel electrodes 21, 23 in FIG. 9b are both rotated by 45 degrees from those in FIG. 8. As can be seen from FIGS. 4 and 8, the sides of the first and second pixel electrodes 21, 23 are parallel to the edges of the whole LCOS device. As can be seen from FIGS. 9a and 9b, the sides of the first and second pixel electrodes 21, 23 are oriented at an angle of 45 degrees with respect to the edges of the whole LCOS device.

Referring to FIGS. 5 to 7, under each second dielectric layer 231, conductive plugs 25 are formed on the corresponding first insulating layer 22. Additionally, the conductive plugs 25 are formed in the vacancy 213 under the corresponding second pixel electrode 23 in order to electrically connect the second dielectric layer 231 to the substrate 20.

The second insulating layer 24 is filled between sidewalls of adjacent second pixel electrodes 23 so that it occupies both the inter-pixel gaps G1 (or G2) between adjacent second pixel electrodes 23 and vacancies (not shown) delimited by the second pixel electrodes 23. In this way, the second insulating layer 24 isolates adjacent second pixel electrodes 23 from each other.

The second insulating layer 24 may be made of at least one of silica, silicon nitride and silicon oxynitride, or of any other suitable insulating material.

The LCOS device may further include an insulating passivation layer 26 and an alignment layer (not shown). As shown in FIG. 6, the insulating passivation layer 26 may cover both the second pixel electrodes 23 and the second insulating layer 24, and the alignment layer may reside on the insulating passivation layer 26.

The insulating passivation layer 26 is provided to protect the second pixel electrodes 23 against influence from the environment and from the subsequent processes, and the alignment layer is configured for liquid crystal orientation control. The insulating passivation layer 26 may be made of at least one of silica, silicon nitride and silicon oxynitride, or of any other suitable insulating material. The alignment layer may be formed of a polymer such as polyimide.

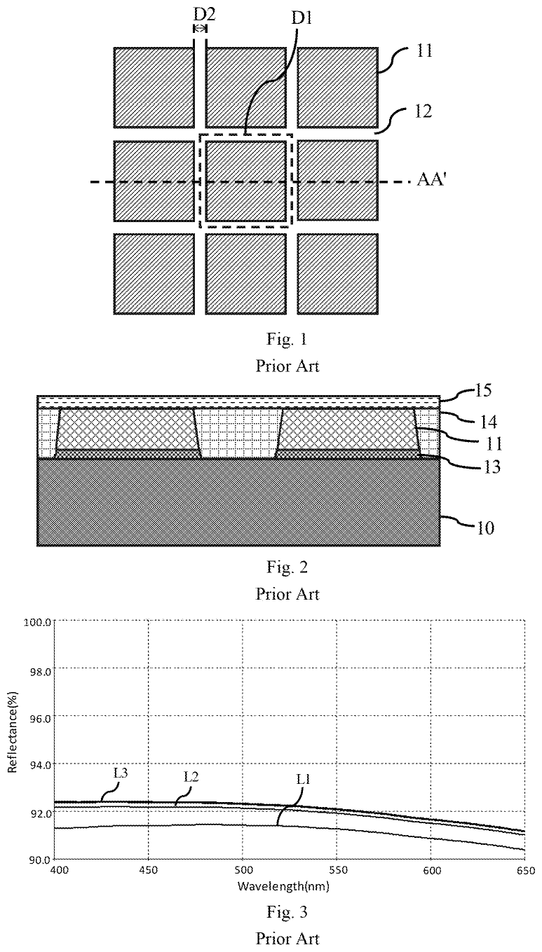

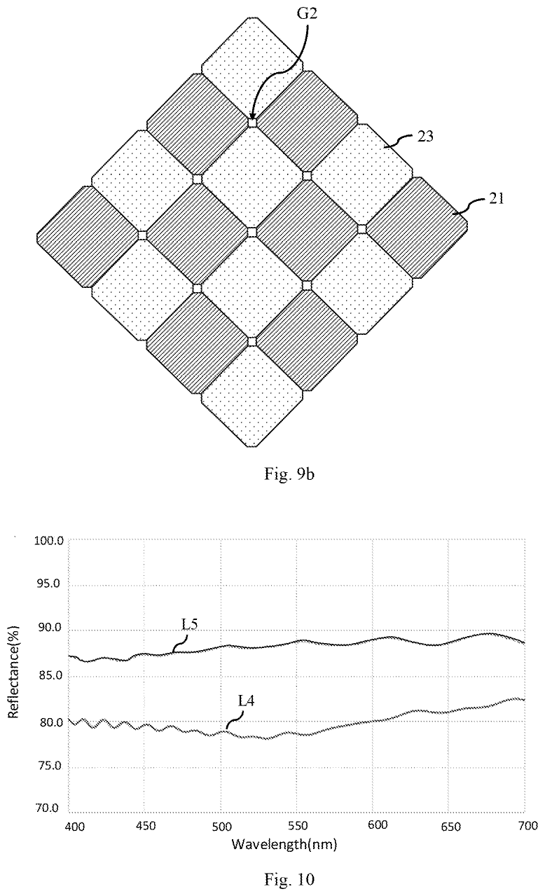

In the above-described structure of the LCOS device, pixel electrodes are grouped into the first and second pixel electrodes that are arranged in separate layers and staggered relative to each other. This results in significant shrinkage of inter-pixel gaps and a more disordered arrangement of pixels, which provides increased immunity against inherent defects in liquid crystal in-plane switching. Thus, the LCOS device has improved performance. In addition, this LCOS device features an aperture ratio as high as 99.6%, much higher than that of the conventional LCOS device shown in FIGS. 1 and 2. Reference is now made to FIG. 10, in which the curve L4 represents a reflectance profile of the conventional LCOS device of FIGS. 1 and 2, and the curve L5 represents a reflectance profile of a LCOS device according to the present invention. Additionally, the horizontal axis (“Wavelength”) represents the wavelength in the visible range (from 400 nm to 700 nm), and the vertical axis (“Reflectance”) represents the reflectance. As can be seen from FIG. 10, the reflectance of the inventive LCOS for visible light is 86%-90%, much higher than the reflectance of the conventional LCOS device that is 77%-83%, indicating a significant improvement in display performance. Therefore, the LCOS device of the present invention achieves an improved aperture ratio and hence increased reflectance not at the expense of a significant increase in cost by employing an improved arrangement of pixel electrodes rather than being fabricated using more expensive sub-nanometer wafer processing techniques.

In summary, the present invention provides a LCOS device, including: a substrate; at least two first pixel electrodes, each corner of each of which is a cutaway corner, and all of which are periodically arranged on the substrate along diagonal directions defined by the cutaway corners; a first insulating layer, which is filled between sidewalls of adjacent first pixel electrodes and covers the first pixel electrodes; at least two second pixel electrodes periodically arranged on the first insulating layer along the diagonal directions, the second pixel electrodes staggered relative to the first pixel electrodes so that inter-pixel gaps are formed between adjacent corners of the second pixel electrodes along the diagonal directions and respective adjacent cutaway corners of the first pixel electrodes along the same directions; and a second insulating layer, which is filled between sidewalls of adjacent second pixel electrodes. This LCOS device has an improved aperture ratio and thus enhanced reflectance while avoiding a significant increase in cost.

In an embodiment of the present invention, there is provided a LCOS display panel including the above-described LCOS device of the present invention, a liquid crystal layer and a transparent cover plate. The LCOS device is bonded to the transparent cover plate by a sealant, and the liquid crystal layer is sandwiched between the LCOS device and the transparent cover plate.

The liquid crystal layer contains liquid crystal molecules, which are oriented under the action of the alignment layer in the LCOS device. The transparent cover plate may be formed of any of light-transmissive materials including glass, silica and plastic. In addition to bonding the LCOS device to the transparent cover plate, the sealant may also function to prevent the ingress of substances from the external environment, such as moisture. Examples of the sealant's material may include acrylic adhesives, epoxy adhesives, UV-curable adhesives, sodium silicate adhesives, etc.

By incorporating the LCOS device of the present invention, which achieves an improved aperture ratio and hence increased reflectance not at the expense of a significant increase in cost by employing an improved arrangement of pixel electrodes rather than being fabricated using more expensive sub-nanometer wafer processing techniques, the LCOS display panel obtains improved display performance while avoiding a significant increase in cost.

The description presented above is merely that of a few preferred embodiments of the present invention and does not limit the scope thereof in any sense. Any and all changes and modifications made by those of ordinary skill in the art based on the above teachings fall within the scope as defined in the appended claims.

1. A liquid crystal on silicon (LCOS) device, comprising:
a substrate;
at least two first pixel electrodes each having a substantially rectangular cross-section defining a first diagonal direction, a second diagonal direction and a length direction, each of the at least two first pixel electrodes having four cutaway corners, the at least two first pixel electrodes being arranged on the substrate along the first diagonal direction;
a first insulating layer, which is filled between sidewalls of adjacent first pixel electrodes and covers the first pixel electrodes;
at least two second pixel electrodes each having a substantially rectangular cross-section and arranged on the first insulating layer along the second diagonal direction, wherein in a projection plane parallel to a surface of the substrate: the second pixel electrodes are alternately arranged with the first pixel electrodes in the length direction; and an inter-pixel gap is formed between corners of adjacent second pixel electrodes along the second diagonal direction and also between cutaway corners of adjacent first pixel electrodes along the first diagonal direction; and
a second insulating layer, which is filled between sidewalls of adjacent second pixel electrodes,
wherein a gap is formed between adjacent cutaway corners of adjacent first pixel electrodes, an edge portion along each side of each of the second pixel electrodes overlapping an underlying side of a corresponding one of the first pixel electrodes, the inter-pixel gap being smaller in area than the gap.

2. The LCOS device of claim 1, wherein the four cutaway corners of the first pixel electrodes are chamfered corners.

3.-4. (canceled)

5. The LCOS device of claim 1, wherein each of the second pixel electrodes has four cutaway corners, and wherein the four cutaway corners of the second pixel electrodes are chamfered corners.

6. The LCOS device of claim 5, wherein each of the first and second pixel electrodes has a substantially square cross-section.

7. The LCOS device of claim 1, wherein each of the second pixel electrodes has four corners that are not cutaway corners.

8. The LCOS device of claim 1, wherein each of the first pixel electrodes has a thickness of from 220 nm to 260 nm and each of the second pixel electrodes has a thickness of from 30 nm to 50 nm.

9. The LCOS device of claim 1, wherein a first dielectric layer is formed between each of the first pixel electrodes and the substrate and a second dielectric layer is formed between each of the second pixel electrodes and the first insulating layer.

10. The LCOS device of claim 9, wherein conductive plugs are formed through the first insulating layer to electrically connect the second pixel electrodes to the substrate.

11. The LCOS device of claim 1, further comprising an insulating passivation layer and an alignment layer, the insulating passivation layer covering both the second pixel electrodes and the second insulating layer, the alignment layer covering the insulating passivation layer.

12. A liquid crystal on silicon (LCOS) display panel, comprising a LCOS device as defined in claim 1, a liquid crystal layer and a transparent cover plate, the LCOS device bonded to the transparent cover plate by a sealant, the liquid crystal layer sandwiched between the LCOS device and the transparent cover plate.
